(19) United States
(12) Patent Application Publication
(10) Pub. No.: US 2022/0084416 A1
(43) Pub. Date: Mar. 17, 2022

(54) INDICATION OF UAV AREAS IN COCKPIT

(71) Applicant: Rockwell Collins, Inc., Cedar Rapids, IA (US)

(72) Inventor: Shivashankar Veerayya Maddanimath, Bangalore (IN)

(73) Assignee: Rockwell Collins, Inc., Cedar Rapids, IA (US)

(21) Appl. No.: 17/101,207

(22) Filed: Nov. 23, 2020

(30) Foreign Application Priority Data
Sep. 11, 2020 (IN) 202041039496

(51) Int. Cl. G08G 5/00; B64D 43/00; B64C 39/02

(52) U.S. Cl. CPC G08G 5/006; G08G 5/003; B64C 2201/123; B64C 39/024; B64D 43/00

(57) ABSTRACT

A system for indicating an unmanned aerial vehicle (UAV) operational area is disclosed. The system includes a database that stores the location of a plurality of UAS operational areas. The system further includes a navigation system and a warning unit communicatively linked to the navigation system and the database. The warning unit includes one or more processors and non-volatile memory communicatively coupled to the one or more processors. The non-volatile memory stores instructions that instruct the one or more processors to: receive position data from the navigation system and UAV data from the data base corresponding to the position data; compare the position data to the UAV data, and process a first image indicating UAV operational areas that are adjacent to an aircraft or a flight path of the aircraft, wherein the first image is displayed on an aircraft display.

### CROSS-REFERENCE TO RELATED APPLICATIONS

The present application claims the benefit under 35 U.S.C. § 119(e) of Indian Provisional Application Serial No. 202041039496, filed Sep. 11, 2020, entitled INDICATION OF UAV AREAS IN COCKPIT, naming Shivashankar V. Maddanimath as inventor, which is hereby incorporated by reference in its entirety.

### BACKGROUND

The prevalence of unmanned aerial vehicles (UAVs) in airspace had increased dramatically in the past few years. UAVs may pose a danger to commercial and private manned aircraft, as collisions between UAVs and these aircraft may lead to structural damage and bodily harm. The small size of many UAVs makes them particularly difficult to detect by pilots and aircraft equipment. Therefore, it would be advantageous to provide a solution that cures the shortcomings described above.

### SUMMARY

A system is disclosed. In one or more embodiments, the system includes a database. The database stores the location of a plurality of unmanned aerial vehicle operational areas. The system also includes a navigation system. The system also includes a display. The system also includes a warning unit. The warning unit is communicatively linked to the navigation system and the database. The warning unit includes one or more processors. The warning unit further includes a non-volatile memory communicatively coupled to the one or more processors. The non-volatile memory stores instructions, which are then executed by the one or more processors. The instructions instruct the one or more processors to receive position data from the navigation system. The instructions also instruct the one or more processors to receive unmanned aerial vehicle data from the database corresponding to the position data. The instructions also instruct the one or more processors to compare the position data to the unmanned aerial vehicle data. The instructions also instruct the one or more processors to process a first image indicating one or more of the plurality of unmanned aerial vehicle operational areas that are adjacent to at least the aircraft or a flight path of the aircraft, wherein the first image is displayed on the aircraft display.

In some embodiments of the system, one or more processors are further configured to determine a safety metric for at least one of the one or more of the plurality of unmanned aerial vehicle operational areas that are adjacent to at least the aircraft or a flight path of the aircraft and determine if the safety metric is above a predetermined threshold, wherein the warning unit is further configured to exhibit a warning if the safety metric is above a predetermined threshold.

In some embodiments of the system, the warning is configured as at least one of an audio signal, a visual signal, or a haptic signal.

In some embodiments of the system, the position data is stored within an aircraft warning database.

In some embodiments of the system, the display is at least one of a primary flight display, a map display, or a navigation display.

In some embodiments of the system, the first image is overlaid upon, or incorporated into, a second image,

In some embodiments of the system, the first image includes one or more icons denoting one or more characteristics of one or more unmanned aerial vehicles within the one or more unmanned aerial vehicle operation areas.

A warning unit is also disclosed. In some embodiments, the warning unit includes one or more processors. In some embodiments, the warning unit further includes a non-volatile memory communicatively coupled to the one or more processors. The non-volatile memory stores instructions, which are then executed by the one or more processors. The instructions instruct the one or more processors to receive position data from a navigation system. The instructions also instruct the one or more processors to receive unmanned aerial vehicle data from a database corresponding to position data. The instructions also instruct the one or more processors to compare the position data to the unmanned aerial vehicle data. The instructions also instruct the one or more processors to process a first image indicating one or more of the plurality of unmanned aerial vehicle operational areas that are adjacent to at least an aircraft or a flight path of the aircraft, wherein the first image is displayed on an aircraft display.

In some embodiments of the warning unit, the warning is configured as at least one of an audio signal, a visual signal, or a haptic signal.

In some embodiments of the warning unit, the position data is stored within an aircraft warning database.

In some embodiments of the warning unit, the display is at least one of a primary flight display, a map display, or a navigation display.

In some embodiments of the warning unit, the first image is overlaid upon, or incorporated into, a second image.

In some embodiments of the warning unit, the first image includes one or more icons denoting one or more characteristics of one or more unmanned aerial vehicles within the one or more unmanned aerial vehicle operation areas.

A method is also disclosed. In one or more embodiments, the method includes receiving position data of an aircraft from an aircraft navigation system via one or more processors within a warning unit. The method further includes receiving unmanned aerial vehicle data from a database storing the location of a plurality of unmanned aerial vehicle operational areas; wherein the unmanned aerial vehicle data corresponds to the position data, wherein the unmanned aerial vehicle data is received via the one or more processors. The method further includes comparing the position data to the unmanned aerial vehicle data via the one or more processors. The method further includes processing a first image via one or more processors indicating one or more of the plurality of unmanned aerial vehicle operational areas that are adjacent to at least the aircraft or a flight path of the aircraft, wherein the first image is displayed on a display.

In some embodiments of the method, the method further includes determining a safety metric for at least one of the one or more of the plurality of unmanned aerial vehicle operational areas that are adjacent to at least the aircraft or a flight path of the aircraft. In some embodiments of the method, the method further includes determining if the safety metric is above a predetermined threshold. In some embodiments of the method, the method includes exhibiting a warning via the warning unit if the safety metric is above a predetermined threshold.

In some embodiments of the method, the warning is configured as at least one of an audio signal, a visual signal, or a haptic signal.

In some embodiments of the method, the position data is stored within an aircraft warning database.

In some embodiments of the method, the first image is overlaid upon, or incorporated into, a second image, wherein the first image is display is a primary flight display, a map display, or a navigation display.

In some embodiments of the method, the first image includes one or more icons denoting one or more characteristics of one or more unmanned aerial vehicles within the one or more unmanned aerial vehicle operation areas.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1A illustrates a system 100 for detection and warning of UAS operational areas, in accordance with one or more embodiments of this disclosure;

FIG. 1B is a flowchart illustrating a method 190 for displaying a first image on a display, in accordance with one or more embodiments of the disclosure.

FIG. 2 illustrates a diagram of a display 145 for the system 100, in accordance with one or more embodiments of this disclosure;

FIG. 3 illustrates a diagram of a display 145 for the system 100, in accordance with one or more embodiments of this disclosure; and

FIG. 4 is a flowchart illustrating a method 400 for indicating UAV operational areas within an aircraft, in accordance with one or more embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

A system, method, and device configured to warn pilots of UAV and unmanned aerial system (UAS) operational areas are disclosed. The system includes a warning unit on-board an aircraft that receives UAV operational area data from a database, and correlates the data with aircraft position data and/or flight plan data derived from a navigation system to determine if the aircraft is approaching a known UAS operational area that could be a potential safety threat to the aircraft. If a UAS operational area is identified as a potential safety threat, the warning unit is configured to display/emit a warning to the pilot of the potential safety threat. For purposes of this disclosure, the terms ‘UAV operational area’ and ‘UAS operational area’ (i.e., a system that includes one or UAVs along with a ground-based controller) may be used interchangeably.

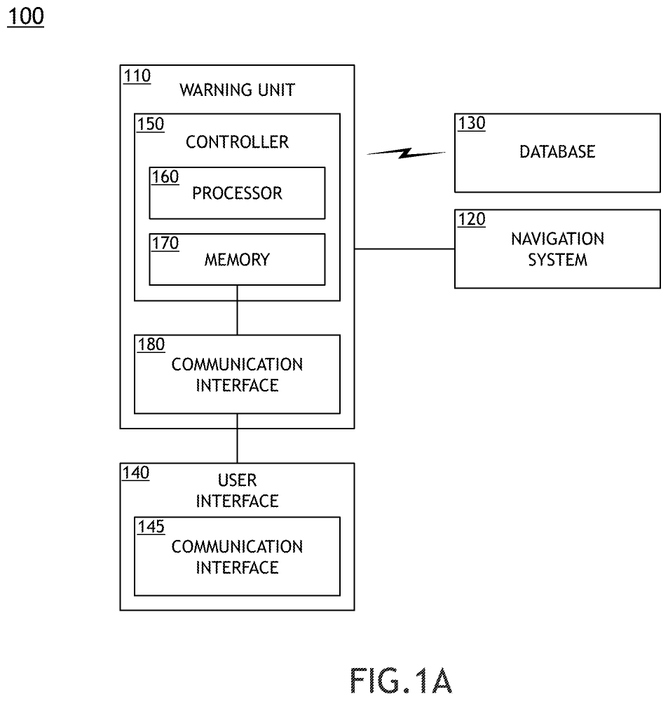

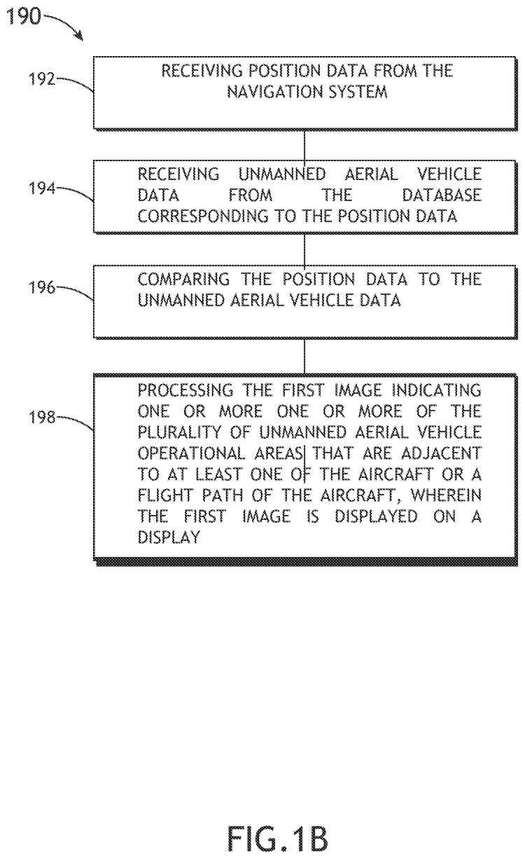

FIG. 1A illustrates a system 100 for detection and warning of UAS operational areas, in accordance with one or more embodiments of this disclosure. The system 100 includes a warning unit 110, in communication with a navigation system 120, a database 130 and a user interface 140. The navigation system 120 is disposed within the aircraft. The warning unit 110 may additionally include, but is not limited to, a controller 150. In embodiments, the system 100 is configured for an aircraft. The system 100 may be configured for any aircraft known, including but not limited to fixed-wing aircraft or rotorcraft.

In embodiments, the warning unit 110 includes hardware, software, and/or firmware configured to execute the various functions or steps described herein. The controller 150 is configured to receive, process, and transmit data within the system 100. The controller 150 includes one or more processors 160 configured to perform functions or steps according to program instructions stored in a memory 170. The controller may also send and receive data and signals via a communication interface 180 to other components of the warning unit 110 and/or the system 100. For example, the controller 150 may be configured to receive UAV operational area data from the database 130 and position data from the navigation system 120, process the data (e.g., compare the UAV operational area data to the position data), and generate and send image data (e.g., data coding for a first image) to the user interface 140.

The user interface 140 may include any device capable of displaying data to a user and/or receiving data input from a user including but not limited to a display 145, a keyboard, a joystick, a mouse, an audio device, or a haptic device. For example, the user interface may include a display 145 in combination with a keyboard. In another example, the user interface may include a display 145 with a touchscreen. The user interface 140 may be physical linked with the warning unit 110. For example, the warning unit 110 and the user interface 140 may be configured as single modular unit. Alternatively, the user interface 140 may be physically detached from the warning unit 110. For example, the user interface 140 and the warning unit 110 may both be on-board an aircraft, but linked only communicatively via a wireline or wireless connection.

In the case of a touchscreen display, those skilled in the art should recognize that a large number of touchscreen displays may be suitable for implementation in the present invention. For instance, the display 145 may be integrated with a touchscreen interface, such as, but not limited to, a capacitive touchscreen, a resistive touchscreen, a surface acoustic based touchscreen, an infrared based touchscreen, or the like. In a general sense, any touchscreen display capable of integration with the system 100 is suitable for implementation in the present invention.

The display 145 may include any type of display device known in the art. For example, the display may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, a cathode-ray tube (CRT), or the like. Those skilled in the art should recognize that a variety of display devices may be suitable for implementation in the present invention and the particular choice of display device may depend on a variety of factors, including, but not limited to, form factor, cost, and the like.

In some embodiments, the user interface 140 may include a display 145 that is part of, or incorporated into, a primary flight display (PFD), an aircraft instrument dedicated to flight information. For example, the display 145 may be configured as a picture-in-picture (PIP) display within a PFD, wherein data from the system 100 is displayed as the first image along with other data from different aircraft systems displayed as a second image. In another example, data from the system 100 is overlaid on a PFD that has incorporates data from other systems. For instance, data from the system 100 may appear as icons on an aircraft display that are overlaid upon, or incorporated into a virtual landscape on the PFD that corresponds to the position of the aircraft. Any configuration of PIP display or overlaid display is possible. For example, the data from the system 100 may be maximized to cover an entire quadrant of the PFD. In another example, the display 145 may be minimized on the PFD. For the purposes of this disclosure, the PFD, and/or a portion of the PFD may be configured as a display 145 for the system 100.

In some embodiments, the user interface 140 may include a display that is part of, or incorporated into, a map display and/or a navigation display. For example, the display may be similarly configured for use with the map display and/or navigation display as described for the PFD described herein.

In some embodiments, the user interface 140 may include any display or type of display used onboard an aircraft. For example, the display may include a primary flight display (PFD). The display may also include any type of virtualized or augmented vision system including but not limited to a synthetic vision system (SVS), a heads-up display (HUD) a head-mounted display (HMD), a virtual reality (VR) system, a mixed reality (MR) system, an augmented reality (AR) system and an extended reality (XR) system. For example, the user interface may be an SVS display, wherein data from the system 100 is incorporated into the SVS display.

In embodiments, the database 130 stores the location of a plurality of operational areas for unmanned aerial vehicles (UAVs) and unmanned aerial systems (UASs). For example, the United States Federal Aviation Administration (FAA) and the United States National Aeronautics and Space Administration (NASA), as well as other industry and national and international administration agencies, are developing an unmanned aerial system traffic management (UTM) ecosystem configured to regulate and monitor unmanned aircraft (e.g., drones) at low altitudes (e.g., less than 400 feet) where air traffic services are typically not provided. Low-flying drones are a growing hazard for aircraft, as their use are becoming more common in areas around airports, increasing the chance that an aircraft may collide with a drone upon takeoff or landing. One possible result of the UTM ecosystem is the creation a database 130 that stores the location of UAS operational areas (e.g., areas that are likely to have UAVs in the air). Data from this database 130 may be then be shared within components of the system 100 allowing the system 100 to warn a pilot that an aircraft may be flying in or near a UAS operational area.

It is noted herein that the one or more components of system 100 may be communicatively coupled to the various other components of system 100 in any manner known in the art. For example, the one or more processors 160 may be communicatively coupled to each other and other components of the system 100 via a wireline (e.g., copper wire, fiber optic cable, and the like) or wireless connection (e.g., RF coupling, IR coupling, Wi-Fi signals, 5G signals, LoRa, Bluetooth, BLE, Zigbee, Z-wave, 6LoWPAN, NFC, WIFI Direct, GSM, LTE. NB-IOT, LTE-M, and the like). For example, the database 130 may communicate with the warning unit 110 via an RF signal. For instance, the database 130 may be configured as a remote server (e.g., ground-based server) that communicates wirelessly with the warning unit 110 via an RF signal. In another example, the database 130 may be configured as an on-board server (e.g., aircraft-based server) that communicates wirelessly with the warning unit 110 via a Bluetooth signal. In another example, database 130 may be configured as an on-board server that communicated with the warning unit 110 via a copper wire connection.

The one or more processors 160 may include any type of processing elements, including but not limited to integrated circuits (e.g., application specific integrated circuits (ASIC) and field programmable gate arrays (FPGA). The controller 150 is not limited by the materials from which it is formed or the processing mechanisms employed therein and, as such, can be implemented via semiconductor(s) and/or transistors (e.g., using electronic integrated circuit (IC) components), and so forth.

The communication interface 180 may be operatively configured to communicate with components of the system 100. For example, the communication interface 180 can be configured to retrieve data from the controller 150 or other devices (e.g., the database 130, the navigation system 120, the user interface 140 and/or components of the warning unit 110), transmit data for storage in the memory 170, retrieve data from storage in the memory 170, and so forth. The communication interface 180 may also be communicatively coupled with the controller 150 to facilitate data transfer between components of the system 100 and the controller 150. It should be noted that while the communication interface 180 is described as a component of the warning unit 110, one or more components of the communication interface 180 may be implemented as external components communicatively coupled to the warning unit 110 via a wireline and/or wireless connection.

The memory 170 can be an example of tangible, computer-readable storage medium that provides storage functionality to store various data and/or program code associated with operation of system 100 and/or controller 150, such as software programs and/or code segments, or other data to instruct the controller 150, and possibly other components of the system 100, to perform the functionality described herein. Thus, the memory 170 can store data, such as a program of instructions for operating the controller, the base node 104 and its components. It should be noted that while a single memory is described, a wide variety of types of combinations of memory (e.g., tangible, non-transitory memory) may be employed. The memory can be integral with the controller 150, can comprise stand-alone memory, or can be a combination of both. Some examples of the memory can include removable and non-removable memory components, such as random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

The navigation system 120 may include any componentry used for aircraft navigation. For example, the navigation system 120 may include a flight management system (FMS). In another example, the navigation system 120 may include a geolocation system (e.g., a global navigational satellite system (GNSS)). For instance, the navigation system 120 may be a geolocation system configured to output an image of a map (e.g., the second image) onto a display (e.g., 2D or 3D map), the map correlating to the current position of the aircraft (e.g., position data). The navigation system 120 may also include one or more navigation databases. For example, the navigation system may include a navigation database (e.g., NAV DB) that stores navigational and/or geographical data. In another example, the navigation system may include an aircraft warning database (e.g., an enhanced ground proximity warning system (EGPWS) database) that provides relevant terrain and obstacle data.

In embodiments, the warning unit 110 incorporates, or may be incorporated into, the database and/or the navigation system. For example, the warning unit 110 may be an add-on module to a navigation system 120 giving the navigation system increased functionality (e.g., to warn of UAV operational areas). In another example, the database 130 may be incorporated into the warning unit 110 (e.g., the warning unit 110 is preloaded with all UAV operational data needed for the flight). In another example, database 130 and the warning unit 110 may be incorporated into the navigational system 120. For instance, the navigation system 120 may include componentry and/or software that comprises the warning unit 110 (e.g., a software upgrade to the navigation system 120 may give the navigation system 120 the functionality of the warning unit 110) and be configured to store and utilize UAV operational data. Many combinations of warning unit 110, navigation system 120 and database 130 are possible within the system 100. Therefore, the above description should not be interpreted as a limitation of the present disclosure, but merely an illustration.

FIG. 1B is a flowchart illustrating a method 190 for displaying the first image on a display, in accordance with one or more embodiments of the disclosure. Instructions for the method 190 are stored in memory 170. These instructions are executed by the one or more processors, causing the one or more processors to perform one or more steps of the method. In embodiments, the method 190 includes a step 192 of receiving position data from the navigation system 120.

In embodiments, the method 190 includes a step 194 of receiving unmanned aerial vehicle data from the database corresponding to the position data. For example, a warning unit 110 that receives position data from a navigation system 120 that the aircraft is approaching the border of a foreign country may also receive unmanned aerial vehicle data from the border indicating areas of possible unmanned aerial vehicle activity.

In embodiments, the method 190 includes a step 196 of comparing the position data to the unmanned aerial vehicle data. For example, the one or more processors 160 may compare the position data to the unmanned aerial vehicle data to determine whether the aircraft is in any danger of moving into an area of high unmanned aerial vehicle activity.

In embodiments, the method 190 includes a step 198 of processing the first image indicating one or more one or more of the plurality of unmanned aerial vehicle operational areas that are adjacent to at least one of the aircraft or a flight path of the aircraft, wherein the first image is displayed on a display. For example, the one or more processors 160, having determined that the aircraft will be entering an unmanned vehicle operation area, may send image data to the user interface 140 resulting in the first image being displayed on the display 145 indicating the unmanned vehicle operation area that is in the flight path of the aircraft.

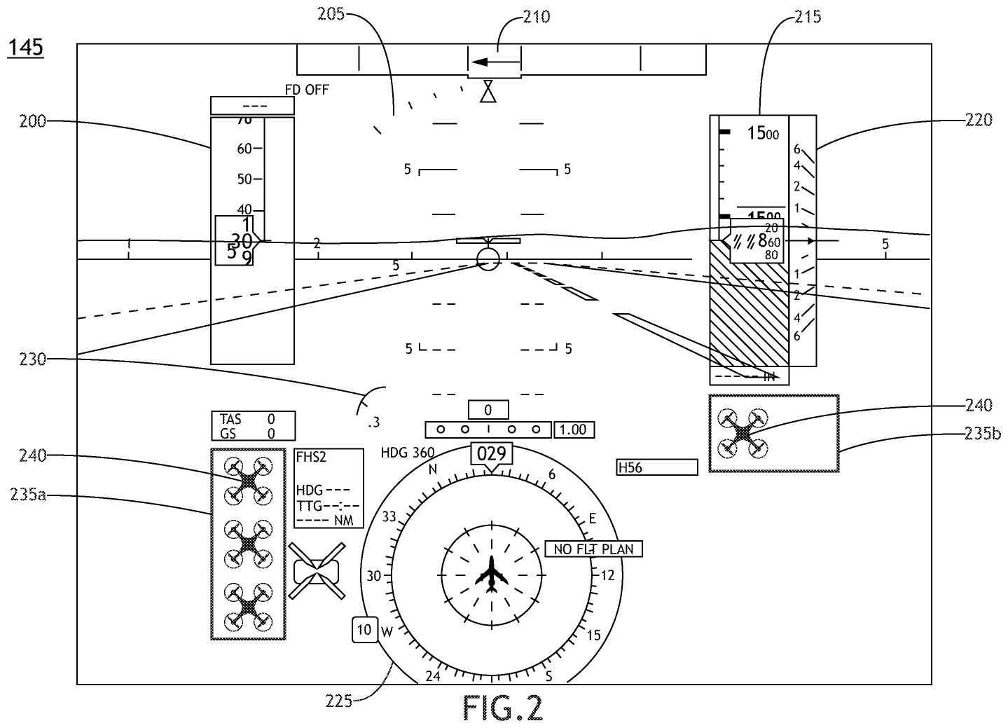

FIG. 2 illustrates a diagram of a display 145 for the system 100, in accordance with one or more embodiments of this disclosure. The display 145 may be configured as a PFD. The display 145 may exhibit several types of virtualized aircraft instruments, including but not limited to an airspeed indicator 200, an attitude indicator 205, a slip skid indicator 210, an altimeter 215, a vertical speed indicator 220, a horizontal situation indicator 225, and/or a turn indicator 230. In embodiments, the display 145 may show or exhibit one or more UAV operational area indicators 235a, 235b warning of the potential presence of unmanned aerial vehicles in the area (i.e., data from the database 130 indicates that UAVs may be flying in the vicinity of the aircraft).

In embodiments, UAV operational area indicators 235a, 235b may be configured to indicate one or more characteristics of the UAV operational area. For example, the UAV operational area indicators 235a, 235b may indicate an area of the UAV operational area. For instance, a larger size of the UAV operational area indicators 235a, 235b on the display 145 may indicate a larger relative size of the UAV operational area. In another instance, the size of the UAV operational area indicators 235a, 235b on the display 145 may indicate the height of the UAV operational area (e.g., the height of the ‘box’ of the UAV operational area indicators 235a, 235b indicating the altitude that UAVs may fly within the UAV operational area. The size and shape of the UAV operational area indicators 235a, 235b are controlled by the warning unit 110 that correlates the UAV operational area data stored in the database 130 to the positional data supplied by the navigation system 120.

The border of the UAV operational area indicators 235a, 235b may be configured to indicate one or more characteristics of the UAV operational area. For example, the color of the border of the UAV may indicate the exigency of the warning to alter the position and/or flight plan of the aircraft. For instance, the border of the UAV operational area indicator 235a, 235b may be configured as yellow or amber to indicate the presence of the UAV operational area and that the aircraft is not in immediate danger. In another example, the border of the UAV operational area indicator 235a, 235b may be configured as red to indicate that the aircraft is in danger of entering the UAV operational area. Any border characteristic of the UAV operational area indicators 235a, 235b may be used to indicate one or more characteristics of the UAV operational area (e.g., border thickness, border intensity, or border pattern). Therefore, the above description should not be interpreted as a limitation of the present disclosure, but merely an illustration.

The UAV operational area indicators 235a, 235b may also include a UAV icon 240. The UAV icon 240 is configured to provide further detail of the UAV operational area. For example, the UAV icon 240 may be configured to indicate the number of UAVs predicted to be in flight within the UAV operational area. For example, a UAV operational area indicator 235a with three UAV icons 240 may indicate a large number of UAVs that are predicted to be flying within the UAV operational area (e.g., greater than 100 UAVs). In another example, a UAV operational area indicator 235b with one UAV icon 240 may indicate a small number of UAVs that are predicted to be flying within the UAV operational area (e.g., less than ten UAVs). The UAV icon 240 may be set to any predetermined number or range of numbers.

The UAV icon 240 may also indicate the type of UAVs that are predicted to be flying within the UAV operational area. For example, the UAV icon 240 may indicate whether the predicted UAV is a commercial predicted to be flying within the UAV operational area is a commercial UAV (e.g., a delivery drone for a delivery service), a civil UAV, a private UAV (e.g., a UAV flown by a UAV hobbyist) or a military/government UAV. The UAV icon 240 may also indicate the relative size of the UAV. For example, the UAV icon 240 may be configured as a large icon for a large military drone. In another example, the UAV icon 240 may be configured as a small icon for a small hobby drone.

The UAV icon 240 may be configured as any design, shape, or size. For example, the UAV icon 240 may be designed to resemble a UAV. For instance, the UAV icon 240 may be designed to resemble a four-rotor UAV (e.g., as in FIG. 2.). In another example, the UAV icon 240 may be configured as an abstract shape. For instance, the UAV icon 240 may be configured as a small square.

The user interface 140 may be further configured to exhibit a visual, audio, and or haptic signal when the aircraft is in danger of entering a UAV operational area. For example, the system 100 may include a display 145 that displays an emergency message (e.g., “UAV area, pull up”) when the aircraft has entered a UAV operational area. In another example, the user interface 140 may include a speaker that emits a siren or a voice message (e.g., “UAV area, pull up”) when the aircraft has entered a UAV operational area. In another example, the user interface 140 may include a haptic device that warns the pilot when the aircraft has entered a UAV operational area. For instance, the user interface 140 may include a cockpit instrument (e.g., a yoke or watch) that vibrates when the aircraft has entered a UAV operation area.

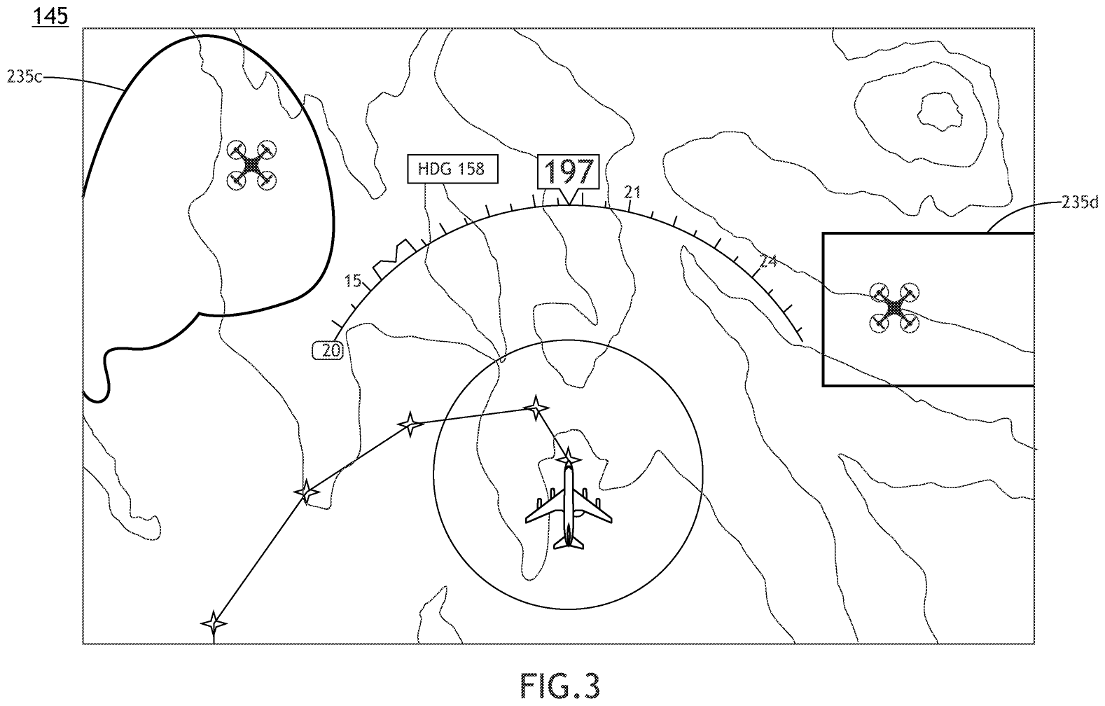

FIG. 3 illustrates a diagram of the display 145 for the system 100 displaying a 2D map of the land area surrounding the aircraft along with UAV operational area indicators 235c, 235d, corresponding to UAV operational areas nearby the aircraft, in accordance with one or more embodiments of this disclosure. The UAV operation area indicators 235c, 235d indicate the UAV operational areas that are predicted to have UAVs currently in flight that may threaten the safety of the aircraft. The UAV operational area indicators 235c, 235d may take any shape as it relates to the UAV operational area data stored in the database 130 and compared by the warning unit 110 to the positional data supplied by the navigation system 120.

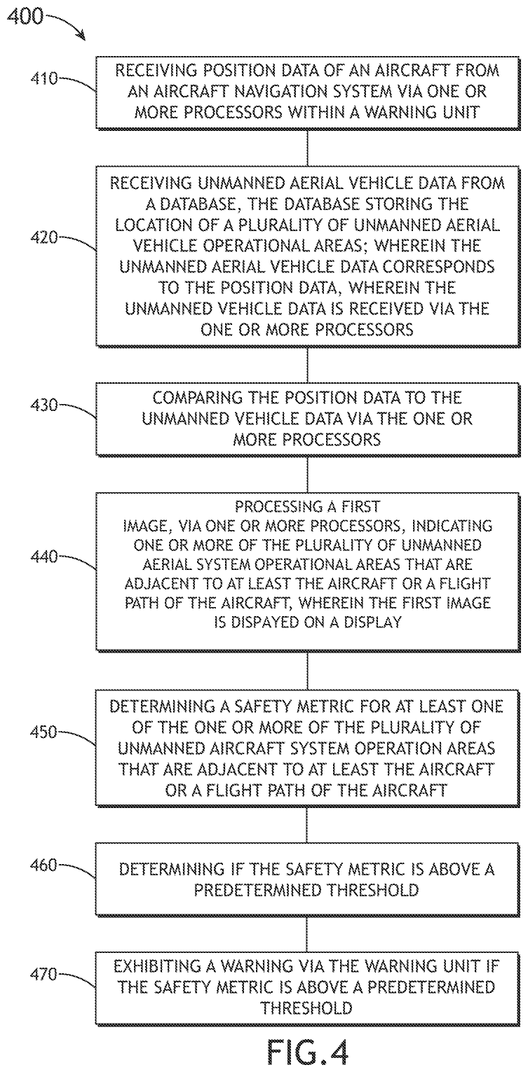

FIG. 4 is a flowchart illustrating a method 400 for indicating UAV operational areas within an aircraft, in accordance with one or more embodiments of this disclosure. In embodiments, the method 400 includes a step 410 of receiving position data of an aircraft from an aircraft navigation system via one or more processors within a warning unit. The position data refers to the relative position of the aircraft to the earth.

In embodiments, the method 400 further include a step 420 of receiving unmanned aerial vehicle (UAV) data from a database, the database storing the location of a plurality of unmanned aerial vehicle operational areas; wherein the unmanned aerial vehicle data corresponds to the position data, wherein the unmanned aerial vehicle data is received via the one or more processors. The UAV data may include any type of data relating to the UAV operational areas including but not limited to operation area boundaries (e.g., length, width, altitude), number of UAVs, type of UAVs, owner of the UAVs, size of the UAVs, and the like).

In embodiments, the method 400 further includes a step 430 of comparing the position data to the unmanned aerial vehicle data via the one or more processors. The method further includes the step 440 of processing a first image via one or more processors indicating one or more of the plurality of unmanned aerial vehicle operational areas that are adjacent to at least the aircraft or a flight path of the aircraft, wherein the first image is displayed on a display 145. The UAV operational areas are indicated by the one or more UAV operational area indicators 235a-d and further described by the UAV icons 240.

In embodiments, the method 400 further includes the step 450 of determining a safety metric for at least one of the one or more of the plurality of unmanned aerial vehicle operational areas that are adjacent to at least the aircraft or a flight path of the aircraft. The safety metric may be any value that may be interpreted as a measurement of risk of an aircraft to a UAV operational area. For example, the safety metric may be a distance (e.g., 1000 meters), that an aircraft is expected to stay away from the UAV operational area. In another example, the safety metric may be a velocity that the aircraft it taking towards a UAV operational area. The safety metric may also depend on the characteristic of the UAV operational area. For example, a safety metric for a UAV operational area containing many large military UAVs may defined as having a higher risk than a safety metric for a UAV operation area having a few, small, hobbyist UAVs.

In embodiments, the method 400 further includes a step 460 of determining if the safety metric is above a predetermined threshold. For example, the warning unit 110 may determine, via data gathered from the database 130 and the navigation system 120 that an aircraft is closer to a UAV operational area (e.g., 900 meters) than the predetermined threshold of 1000 meters.

In embodiments, the method 400 further includes a step 470 of exhibiting a warning via the warning unit 110 if the safety metric is above a predetermined threshold. For example, the warning unit 110 may, via the one or more processors 160, generate a first image to be displayed on the display 145 the text “UAV operational area, pull up”. The one or more processors 160 may also generate a voice message for a speaker to state a similar message, or generate a haptic response to be relayed to a haptic device warning the pilot.

In embodiments, the system 100 includes, or is incorporated with, other warning systems within the aircraft. For example, the system 100 may be incorporated with an enhanced ground proximity warning system (EGPWS). For instance, the warning unit 110 may send data to the EGPWS that the aircraft has moved too close to a UAV operational area. The EGPWS may be configured to receive that data form the warning unit 110, and generate a visual and/or audio warning that is received by the pilot.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system, comprising:
a database configured to store a location of a plurality of unmanned aerial vehicle operational areas;
an aircraft comprising:
a navigation system;
a display; and
a warning unit communicatively linked to the navigation system and the database, comprising:
one or more processors; and
a non-volatile memory communicatively coupled to the one or more processors and having instructions stored thereon, which when executed by the one or more processors, causing the one or more processors to:
receive position data from the navigation system;
receive unmanned aerial vehicle data from the database corresponding to the position data;
compare the position data to the unmanned aerial vehicle data; and
process a first image indicating one or more of the plurality of unmanned aerial vehicle operational areas that are adjacent to at least one of the aircraft or a flight path of the aircraft, wherein the first image is displayed on the aircraft display.

2. The system of claim 1, wherein the one or more processors are further configured to determine a safety metric for at least one of the one or more of the plurality of unmanned aerial vehicle operational areas that are adjacent to at least the aircraft or the flight path of the aircraft and determine if the safety metric is above a predetermined threshold, wherein the warning unit is further configured to exhibit a warning if the safety metric is above the predetermined threshold.

3. The system of claim 2, wherein the warning is configured as at least one of an audio signal, a visual signal, or a haptic signal.

4. The system of claim 1, wherein the position data is stored within an aircraft warning database.

5. The system of claim 1, wherein the display is at least one of a primary flight display, a map display, or a navigation display.

6. The system of claim 1, wherein the first image is overlaid upon, or incorporated into, a second image.

7. The system of claim 1, wherein the first image includes one or more icons denoting one or more characteristics of one or more unmanned aerial vehicles within the one or more unmanned aerial vehicle operation areas.

8. A warning unit comprising:
one or more processors; and
a non-volatile memory communicatively coupled to the one or more processors and having instructions stored thereon, which when executed by the one or more processors, causing the one or more processors to:
receive position data from a navigation system, wherein the navigation system is disposed in an aircraft;
receive unmanned aerial vehicle data from a database, the database storing a location of a plurality of unmanned aerial vehicle operational areas; wherein the unmanned aerial vehicle data corresponds to the position data;
compare the position data to the unmanned aerial vehicle data; and
process a first image indicating one or more of the plurality of unmanned aerial vehicle operational areas that are adjacent to at least one of the aircraft or a flight path of the aircraft, wherein the first image is displayed on a display.

9. The warning unit of claim 8, wherein the one or more processors are further configured to determine a safety metric for at least one of the one or more of the plurality of unmanned aerial vehicle operational areas that are adjacent to at least the aircraft or the flight path of the aircraft and determine if the safety metric is above a predetermined threshold, wherein the warning unit is further configured to exhibit a warning if the safety metric is above the predetermined threshold.

10. The warning unit of claim 9, wherein the warning is configured as at least one of an audio signal, a visual signal, or a haptic signal.

11. The warning unit of claim 8, wherein the position data is stored within an aircraft warning database.

12. The warning unit of claim 8, wherein the display is at least one of a primary flight display, a map display, or a navigation display.

13. The system of claim 8, wherein the first image is overlaid upon, or incorporated into, a second image.

14. The warning unit of claim 8, wherein the first image includes one or more icons denoting one or more characteristics of one or more unmanned aerial vehicles within the one or more unmanned aerial vehicle operation areas.

15. A method comprising:
receiving position data of an aircraft from an aircraft navigation system via one or more processors within a warning unit;
receiving unmanned aerial vehicle data from a database, the database storing a location of a plurality of unmanned aerial vehicle operational areas; wherein the unmanned aerial vehicle data corresponds to the position data, wherein the unmanned aerial vehicle data is received via the one or more processors;
comparing the position data to the unmanned aerial vehicle data via the one or more processors;
processing a first image via the one or more processors indicating one or more of the plurality of unmanned aerial vehicle operational areas that are adjacent to at least the aircraft or a flight path of the aircraft, wherein the first image is displayed on a display.

16. The method of claim 15, further comprising:
determining a safety metric for at least one of the one or more of the plurality of unmanned aerial vehicle operational areas that are adjacent to at least the aircraft or the flight path of the aircraft;
determining if the safety metric is above a predetermined threshold, and
exhibiting a warning via the warning unit if the safety metric is above the predetermined threshold.

17. The method of claim 16, wherein the warning is configured as at least one of an audio signal, a visual signal, or a haptic signal.

18. The method of claim 15, wherein the position data is stored within an aircraft warning database.

19. The method of claim 15, wherein the first image is overlaid upon, or incorporated into, a second image, wherein the first image is displayed on a primary flight display, a map display, or a navigation display.

20. The method of claim 15, wherein the first image includes one or more icons denoting one or more characteristics of one or more unmanned aerial vehicles within the one or more unmanned aerial vehicle operation areas.
